(19) United States
(12) Patent Application Publication
(10) Pub. No.: US 2003/0139502 A1
(43) Pub. Date: Jul. 24, 2003

(54) Cosmetic compositions comprising a cationic polymer/anionic surfactant mixture and use of said mixture as conditioning agent

(76) Inventor: Jean-Marc Ricca, Singapore (SG)

Correspondence Address: BURNS DOANE SWECKER & MATHIS L L P, POST OFFICE BOX 1404, ALEXANDRIA, VA, 22313-1404, US

(21) Appl. No.: 10/182,143

(22) PCT Filed: Jan. 29, 2001
(86) PCT No.: PCT/FR01/00275

(51) Int. Cl. C08K 5/41; C08K 5/42; C08K 5/04

(52) U.S. Cl. 524/156; 524/157; 524/394

(57) ABSTRACT

The invention concerns aqueous cosmetic compositions comprising a mixture: of at least an anionic surfactant, with a content of the order of 0.001 to 1.5 wt %; of at least a cationic polymer, with a content of the order of 0.01 to 2 wt. %, said cationic polymer being selected such that the viscosity ratio Vs, defined as the relationship between maximum viscosity in the presence of surfactant and the viscosity in the absence of surfactant, is at least more than 2. The invention also concerns the use of said mixture as conditioning agent for aqueous cosmetic compositions.

The present invention relates to aqueous cosmetic compositions comprising a mixture of at least one cationic polymer and at least one anionic surfactant, and to the use of said mixture as a structuring agent in aqueous cosmetic compositions, more particularly for the hair and/or skin.

Cosmetic products for treating the hair or skin, or more generally keratinous substances, need to have a particular rheology for application to the skin. Numerous substances have been developed for producing the desired rheological properties, but they have generally not been satisfactory from the sensorial point of view.

Examples of such substances that can be cited are non-ionic cellulose derivatives such as hydroxyethyl or hydroxypropyl celluloses.

Recently, associative polymers in the presence of surfactants have been developed. Grafting alkyl chains onto hydrosoluble polymers endows the latter with associative properties in the presence of anionic surfactants, resulting in compositions with a satisfactory theological profile. However, preparation of such compositions has proved difficult and economically unsatisfactory. Further, such compounds make little or no contribution to the cosmetic properties of the compositions.

It has unexpectedly been discovered that certain cationic polymers have an associative character in the presence of surfactants, resulting in compositions with novel textures. The combination of such compounds (polymer(s) and surfactant(s)), even in very low concentrations, causes the appearance of structured phases: the stability of those phases renders them them compatible with use in the cosmetic field.

In a first aspect, then, the invention concerns an aqueous cosmetic composition comprising a mixture:

of at least one anionic surfactant, in an amount of the order of 0.001% to 1.5% by weight;

of at least one cationic polymer, in an amount of the order of 0.01% to 2% by weight, said cationic polymer being selected so that the viscosity ratio Vs, defined as the ratio between the maximum viscosity in the presence of surfactant and the viscosity in the absence of surfactant, is a minimum of 2.

In a further aspect, the present invention concerns the use of a mixture comprising:

of the order of 0.001% to 1.5% by weight of at least one anionic surfactant;

of the order of 0.01% to 2% by weight of at least one cationic polymer, the cationic polymer being selected so that the viscosity ratio Vs, defined as the ratio between the maximum viscosity in the presence of surfactant and the viscosity in the absence of surfactant, is a minimum of 2;

as a structuring agent for aqueous cosmetic compositions.

It has been established that, particularly advantageously, aqueous cosmetic compositions comprising the cationic polymer(s)/surfactant(s) mixture have the appearance of a homogeneous gel with properties that are at least equivalent, and frequently superior, to those obtained with the non-ionic hydrosoluble associative polymers mentioned above.

Further, the mixture used in the cosmetic compositions of the invention not only possesses structuring properties for said compositions, but also provides cosmetic properties, which was not the case, or was only slightly the case for compositions comprising the associative polymers cited above.

Further advantages and characteristics will become apparent from the following description, figures and examples.

The accompanying figures show:

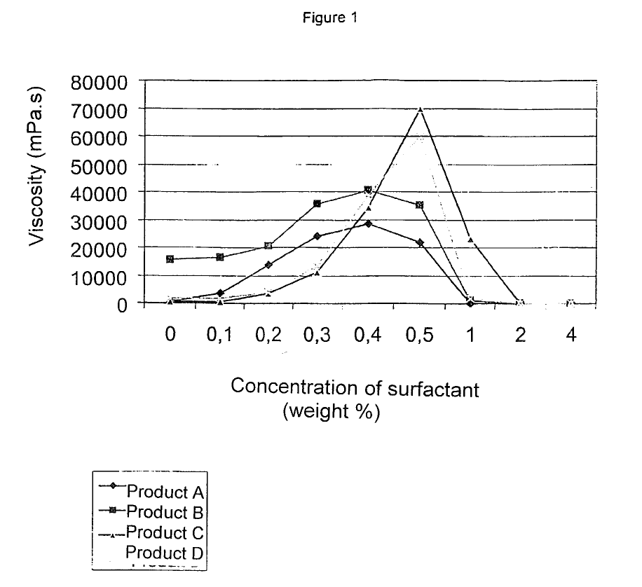

In FIG. 1 the change in the viscosity of aqueous cosmetic compositions as a function of the concentration by weight of surfactant for compositions of the invention;

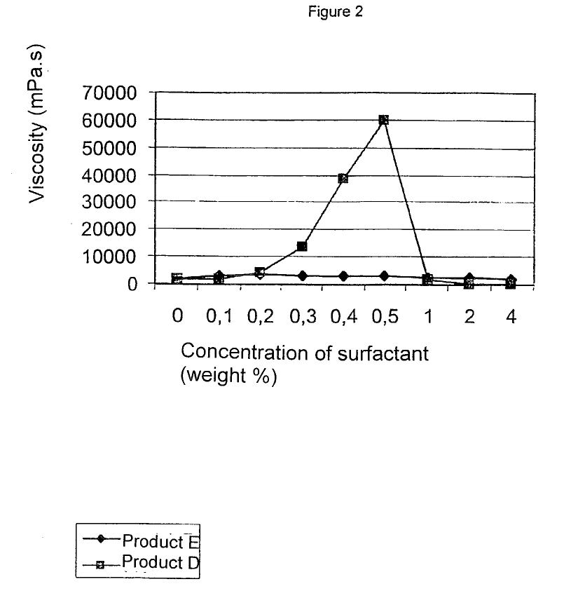

In FIG. 2, the change in the viscosity of aqueous cosmetic compositions as a function of the concentration by weight of surfactant for a composition of the invention and a composition comprising an associative polymer in accordance with the prior art;

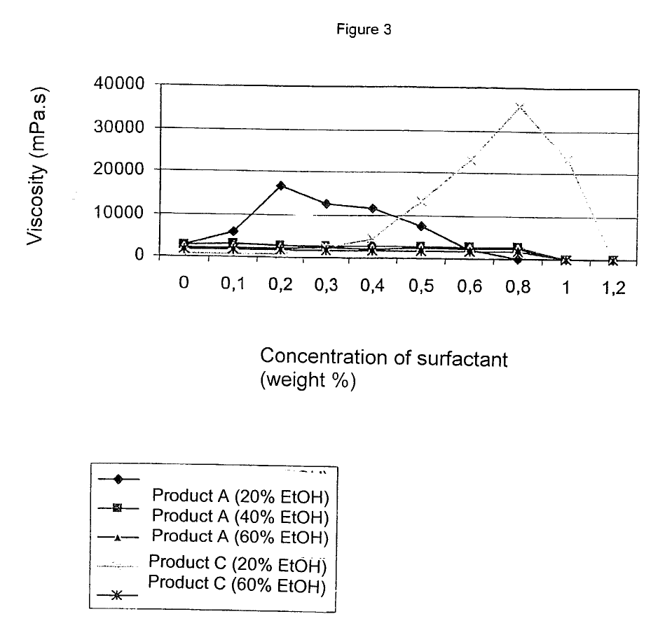

In FIG. 3, the change in the viscosity of aqueous cosmetic compositions comprising an alcohol, as a function of the concentration by weight of surfactant, for compositions of the invention and compositions comprising an associative polymer in accordance with the prior art.

It should be noted that the nomenclature used below for the compounds is in accordance with the international nomenclature for cosmetic ingredients (INCI).

As indicated above, the compositions of the invention comprise a mixture:

of at least one anionic surfactant, in an amount of the order of 0.001% to 1.5% by weight;

of at least one cationic polymer, in an amount of the order of 0.01% to 2% by weight, said cationic polymer being selected so that the viscosity ratio Vs, defined as the ratio between the maximum viscosity in the presence of surfactant and the viscosity in the absence of surfactant, is a minimum of 2.

More advantageously, the ratio Vs is in the range 10 to 50.

The viscosity is measured with a Brookfield apparatus, rotor n° 4, at 25° C., at a speed of 1 rpm and a pH of 6.5.

In a more particular embodiment of the invention, the compositions comprise of the order of 0.1% to 1% by weight of at least one anionic surfactant. In a preferred embodiment of the invention, the amount of anionic surfactant is in the range 0.35% to 0.55% by weight.

Regarding the amount of cationic polymer, this is more particularly in the range 0.01% to 1% by weight of cationic polymer, preferably of the order of 0.01% to 0.5% by weight of cationic polymer. More preferably, the amount of cationic polymer is in the range 0.05% to 0.5% by weight.

More particularly, the cationic polymers used in the present invention have a strong associative nature in the presence of anionic surfactants.

This associative nature usually results in the phenomenon of phase separation of a polymer/surfactant complex during dilution of a mother solution.

This associative nature can be identified by a simple test consisting of preparing a solution of cationic polymer to be tested (0.3% by weight) in a mixture of sodium laureth-2-sulphate (9% by weight)/disodium cocoamphodiacetate (3%). This solution, with its pH adjusted to 6, is then incrementally diluted by adding deionised water, and the transmittance is measured at 600 nm. If the transmittance drops below 90% during dilution, this indicates the presence of a phase separation phenomenon characterizing the associative behaviour of the test polymer.

It should be noted that cationic polymers do not exhibit such behaviour, for example cationic polymers such as Polyquaternium-7 or Polyquaternium-2.

Particular cationic polymers that can be used in the present invention include cationic derivatives of polysaccharides, such as guar or cellulose derivatives.

It should be noted that the scope of the present invention encompasses using cationic polymers functionalised by hydrophobic groups such as C₁-C₁₄ alkyl chains, preferably C₂-C₈, with an optional hydroxyl group. These hydrophobic groups are connected to the principal polymeric chain via ether bonds.

Further, and in the case of hydrophobically or non hydrophobically modified cationic guars, the cationic group is a quaternary ammonium group carrying three radicals, which may or may not be identical, selected from hydrogen, an alkyl radical containing 1 to 22 carbon atoms, more particularly 1 to 14, advantageously 1 to 3 carbon atoms. The counter-ion is a halogen, preferably chlorine.

In the case of hydrophobically or non hydrophobically modified cationic celluloses, the cationic group is a quaternary ammonium group carrying three radicals, which may or may not be identical, selected from hydrogen, an alkyl radical containing 1 to 10 carbon atoms, more particularly 1 to 6, advantageously 1 to 3 carbon atoms. The counter ion is a halogen, preferably chlorine.

Guar derivatives that can be cited include guar hydroxypropyl trimonium chloride (JAGUAR C13S, C14S, C17 sold by Rhodia Chimie) or hydroxypropyl guar hydroxypropyl trimonium chloride (JAGUAR C162 sold by RHODIA).

Cellulose derivatives that can be used include the ether of poly(oxyethanediyl-1,2)-2-hydroxychloride, trimethylammonium-3-propyl cellulose or polyquaternium-10, such as Polymer JR400 sold by Union Carbide.

Synthetic polymers are also suitable, more particularly homopolymers such as poolymethacrylamidopropyl trimonium chloride (Polycare 133 sold by Rhodia Chimie).

More particularly, the cationic polymers have a mass average molar mass of at least 2000 g/mol, more preferably in the range 2×10⁴ to 3×10⁶ g/mol, depending on their degree of polymerisation. The mass average molar masses of polymers is normally measured by size exclusion. They can optionally be measured directly by light diffusion or from the intrinsic viscosity using a calibration as described in “Viscosity-molecular weight relationship, intrinsic chain flexibility and dynamic solution properties of guar galactomannan) by G. Robinson, S. B. Ross Murphy, E. R. Morris, Carbohydrate Research 107, p. 17-32, 1982.

In the case of cationic polysaccharide derivatives, the degree of hydroxyalkylation (molar substitution or MS) is preferably in the range 0 to 1.2. Still with these polymers, the degree of cationicity (degree of substitution or DS) is more particularly in the range 0.01 to 0.6. This is the case, for example, with Jaguar C162 and C2000 sold by Rhodia Chimie.

Preferably, the mixture comprises at least one polysaccharide as defined above. More preferably, the cationic polymers are cationic guar derivatives.

The cationic polymer is associated with at least one anionic surfactant.

Examples of anionic surfactants that can be used in the context of the present invention that can be cited are:

alkylester sulphonates with formula R—CH(SO₃M)—COOR′, where R represents a C₈-C₂₀ alkyl radical, preferably C₁₀-C₁₆, R′ represents a C₁-C₆ alkyl radical, preferably C₁-C₃, and M represents an alkali cation (sodium, potassium, lithium), ammonium substituted or non substituted (methyl-, dimethyl-, trimethyl-, tetramethylammonium, dimethylpiperidnium . . . ) or derived from an alkanolamine (monoethanolamine, diethanolamine, triethanolamine . . . ). More particularly, methyl ester sulphonates where radical R is C₁₄-C₁₆ can be cited;

alkylsulphates with formula ROSO₃M, where R represents a C₁₀-C₂₄ alkyl or hydroxyalkyl radical, preferably C₁₂-C₂₀ and more particularly C₁₂-C₁₈, M represents a hydrogen atom or a cation with the same definition as above, and their oxyalkylenated (oxyethylenated and/or propoxylenated) derivatives with an average of 0.5 to 6 motifs, preferably 0.5 to 3 oxyalkylenated motifs;

alkylamide sulphates with formula RCONHR′OSO₃M where R represents a C₂-C₂₂ alkyl radical, preferably C₆-C₂₀, R′ represents a C₂-C₃ alkyl radical, M represents a hydrogen atom or a cation with the same definition as above, and their oxyalkylenated (oxyethylenated and/or propoxylenated) derivatives with an average of 0.5 to 60 motifs oxyalkylenated motifs;

salts of saturated or unsaturated C₈-C₂₄ fatty acids, preferably C₁₄-C₂₀, C₉-C₂₀ alkylbenzenesulphonates, primary or secondary C₈-C₂₂ alkylsulphonates, alkylglycerolsulphonates, sulphonated polycarboxylic acids described in British patent GB-A-1 082 179, paraffin sulphonates, N-acyl-N-alkyltaurates, alkylphosphates, alkylisethionates, alkylsuccinamates, alkylsulphosuccinates, sulphosuccinate monoesters or diesters, N-acylsarcosinates, alkylglycoside sulphates or polyethoxycarboxylates.

In a preferred embodiment of the invention, the anionic surfactant is a derivative of a fatty alcohol or an oxyalkylenated sulphated fatty acid, preferably an oxyethylenated derivative. Lauric alcohol derivatives such as sodium or magnesium lauryl ether sulphate or mixtures thereof are particularly suitable for use in the invention.

The scope of the present invention encompasses using one or more anionic surfactants. Anionic surfactants, preferably used with sulphate type anionic surfactants, that can be cited are sulphosuccinates, monoalkyl phosphates or alkyl ether carboxylates.

The anionic surfactant can optionally be associated with at least one amphoteric or zwitterionic surfactant.

Surfactants that can be used as a constituent in the composition of the invention that can be cited include amino acid derivatives such as betaines, which are zwitterionic or amphoteric compounds.

The term “betaine type zwitterionic surfactant” means a surfactant carrying a pH-permanent negative and a positive charge on the same molecule and which does not have an isoelectric point. They are quaternised derivatives; examples that can be cited are:

betaines:

R₁R₂R₃⁺NR₄C(O)O⁻

such as lauryl betaine (Mirataine BB from Rhodia Chimie);

sulphobetaines:

R₁R₂R₃⁺NR₄SO₃⁻;

amidoalkylbetaines:

R₁C(O)—NH R₂⁺N(R₃R₄)R₅C(O)O⁻

such as cocamidopropyl betaine (Mirataine BDJ from Rhodia Chimie);

sulphobetaines:

R₁C(O)—NH R₂⁺N(R₃R₄)R₅SO₃⁻

such as cocamidopropyl hydroxysultaine (Mirataine CBS from Rhodia Chimie).

In said formulae, radical R₁ represents an alkyl or alkenyl radical containing 10 to 24 carbon atoms, R₂, R₃, R₄ and R₅, which may be identical or different, represent an alkyl or alkylene radical containing 1 to 4 carbon atoms.

The term “amphoteric surfactant” means a surfactant carrying both an anionic charge and a cationic charge, wherein the degree of ionisation varies as a function of the pH of the medium in which it is found. Such products have an isoelectric point (IEP) in the range 3.5 to 6.5. This isoelectric point can be adjusted by changing the by-products of the product.

Examples which can be cited are:

cocoamphoacetates and cocoamphodiacetates more generally with formula:

7/1

where R₁ represents an alkyl or alkenyl radical containing 10 to 24 carbon atoms, and more particularly represents coco and lauryl chains (Miranol C2M and Miranol Ultra C32 from Rhodia Chimie);

alkylamphopropionates or -dipropionates (Miranol C2M SF from Rhodia Chimie);

alkyl amphohydroxypropyl sultaines (Miranol CS from Rhodia Chimie).

It is also possible to use non ionic surfactants such as ethoxylated derivatives of sorbitan esters, alkylpolyglucosides, alkylglucosamides, or ethoxylated fatty acids, alcohols, amides, or amines.

In a particularly advantageous variation of the present invention, at least one surfactant is used selected from sulphates, optionally combined with a co-surfactant, which may or may not be ionic.

In that variation, the concentration of surfactant and optional co-surfactant is more advantageously in the range 10⁻² to 10 times the value of the critical micellar concentration of the surfactant of of the surfactant mixture. Preferably, this concentration is in the range 0.5 to 1.6 times the value of the critical micellar concentration.

These cationic polymer/surfactant mixtures can be prepared in a conventional manner. As an example, a solution/suspension of polymer in water can be prepared using methods that are known to the skilled person, followed by adding one or more surfactants to produce the desired rheology.

The mixtures described above can advantageously be used in aqueous cosmetic compositions as a texturing agent.

The mixture of the invention can substantially increase the viscosity of the cosmetic composition into which it is introduced, until that composition gels.

This mixture is then used to produce aqueous cosmetic compositions.

The term “cosmetic composition (or formulation)” means any cosmetic product or preparation as described in the annex “Illustrative list by category of cosmetic products” in European Directive n° 76/768/CEE dated Jul. 27, 1976, known as the cosmetics directive.

The cosmetic compositions of the invention can be formulated in a wide variety of products types for the skin and/or hair, as gels (primarily for hairdressing), conditioners, formulations for setting or facilitating comb-through, lotions for the hand and body, skin moisturising products, toilet milks, and other compositions of that type.

The cosmetic compositions of the invention can, for example, contain silicone derivatives, which may or may not be soluble in the water of the cosmetic composition.

Silicone derivatives that are soluble in the water of the composition that can be cited include dimethicone copolyols (Mirasil DMCO sold by Rhodia Chimie).

Regarding silicones in the form of dispersions that are insoluble in the water of the composition, it is possible to use non hydrosoluble and non volatile polyorganosiloxanes (also known as “non hydrosoluble and non volatile silicones”) including polyalkylsiloxane, polyarylsiloxane or polyalkylarylsiloxane oils, gums or resins, or their non hydrosoluble functionalised derivatives, or non volatile mixtures thereof.

Said organopolysiloxanes are considered to be non hydrosoluble and non volatile when their solubility in water is less than 50 g/litre and their intrinsic viscosity is at least 3000 mPa.s. at 25° C.

Examples of non hydrosoluble and non volatile polyorganosiloxanes that can be cited are silicone gums such as diphenyl dimethicone gum sold by Rhodia Chimie, preferably polydimethylsiloxanes with a viscosity of at least 6×10⁵ mPa.s at 25° C., more preferably those with a viscosity of more than 2×10⁶ mPa.s at 25° C., such as Mirasil DM500000 sold by Rhodia Chimie.

In accordance with the invention, the non hydrosoluble and non volatile polyorganosiloxane or silicone is in the dispsersed form in the cosmetic composition containing it.

This is present in the form of particles the size of which can be selected as a function of the nature of the cosmetic composition or the desired performance of that composition. In general, this size can be between 0.01 and 70 microns.

Preferably, this size is of the order of 0.1 to 50 microns, more particularly of the order of 1 to 30 microns.

To facilitate using them, said polyorganosiloxanes can be dispersed or dissolved in advance in low viscosity silicone derivatives, which latter may or may not be volatile, then emulsified in the cosmetic composition.

Low viscosity silicones that can be cited are cyclic volative silicones and low molecular weight polydimethylsiloxanes.

It is also possible to use functionalised silicone derivatives, such as amine derivatives, directly in the form of emulsions or from a micro-emulsion formed in advance, such as Mirasil ADM-E (amodimethicone) sold by Rhodia Chimie.

It is also possible to use oils that may act as conditioners, protecting agents, or emollients. Such oils are generally selected from alkylmonoglycerides, alkyldiglycerides, triglycerides such as oils extracted from plants and vegetables (palm, coprah, cottonseed, soya, sunflower, olive, grapeseed, sesame, peanut, castor oil, etc.) or of animal origin (tallow, fish oils, etc..), derivatives of those oils such as hydrogenated oils, lanolin derivatives, petrolatum, mineral oils or paraffin oils, perhydrosqualane, squalene, diols such as 1,2-dodecanediol, cetyl alcohol, stearyl alcohol, oleic alcohol, fatty esters such as isopropyl palmitate, 2-ethylhexyl cocoate, myristyl myristate, or esters of lactic acid, stearic acid, behenic acid or isostearic acid.

It is also possible to incorporate the following into the cosmetic composition in the form of dispersions or solutions: bactericidal or fungicidal agents to improve skin disinfection, for example triclosan; anti-dandruff agents, such as zinc pyrithione or octopyrox; or insecticidal agents such as natural or synthesised pyrethroids.

The cosmetic compositions can also contain agents for protecting the skin and/or hair against attack from the sun and UV radiation. The compositions can comprise sunscreens, chemical compounds that strongly absorb UV radiation, such as compounds authorised in European Directive N° 76/768/CEE, and its annexes and amendments.

When the solubility of the various constituent elements of the cosmetic composition is too low in the composition or when it is solid at ambient temperature, said constituent elements can advantageously be dissolved in an organic vehicle such as mineral or natural oils, silicone derivatives or waxes, or they may be encapsulated in matrices such as latex type polymers.

The cosmetic compositions of the invention can also contain fixative resins.

When present, these fixative resins are generally in concentrations in the range 0.01% to 10%, preferably in the range 0.5% to 5%.

More particularly, fixative resins that can be used in the cosmetic compositions are selected from the following resins:

methyl acrylate/acrylamide copolymers, polyvinylmethylether/maleic anhydride copolymers, vinyl acetate/crotonic acid copolymers, octylacrylamide/methyl acrylate/butylaminoethylmethacrylate copolymers, polyvinylpyrrolidones, polyvinylpyrrolidone/methyl methacrylate copolymers, polyvinylpyrrolidone/vinyl acetate copolymers, polyvinyl alcohols, polyvinyl alcohol/crotonic acid copolymers, polyvinyl alcohol/maleic anhydride copolymers, hydroxypropyl celluloses, hydroxypropyl guars, sodium polystyrene sulphonates, polyvinylpyrrolidone/ethyl methacrylate/methacrylic acid terpolymers, poly(methylvinyl ether/maleic acid) monomethyl ethers, and polyvinylacetates grafted onto polyoxyethylenated backbones (EP-A-0 219 048);

copolyesters derived from a terephthalic and/or isophthalic and/or sulphoisophthalic acid, anhydride or diester and a diol, such as:

polyester copolymers based on ethylene terephthalate and/or propylene terephthalate and polyoxyethylenated terephthalate motifs (U.S. Pat. No. 3,959,230, U.S. Pat. No. 3,893,929, U.S. Pat. No. 4,116,896, U.S. Pat. No. 4,702,857 and U.S. Pat. No. 4,770,666);

sulphonated polyester oligomers obtained by sulphonation of an oligomer derived from ethoxylated allyl alcohol, dimethylterephthalate and 1,2 propylene diol (U.S. Pat. No. 4,968,451);

polyester copolymers derived from dimethylterephthalate, isophthalic acid, dimethyl sulphoisophthalate and ethylene glycol (EP-A-0 540 374);

copolymers comprising polyester units derived from dimethylterephthalate, isophthalic acid, dimethyl sulphoisophthalate and ethylene glycol and polyorganosiloxane units (FR-A-2 728 915);

sulphonated polyester oligomers obtained by condensation of isophthalic acid, dimethyl sulphosuccinate and diethylene glycol (FR-A-2 236 926);

polyester copolymers based on propylene terephthalate and polyoxyethylene terephthalate and terminated by ethyl, methyl moieties (U.S. Pat. No. 4,711,730) or polyester oligomers terminated by alkylpolyethoxy groups (U.S. Pat. No. 4,702,857) or anionic sulphopolyethoxy groups (U.S. Pat. No. 4,721,580) or sulphoaroyl groups (U.S. Pat. No. 4,877,896);

polyester-polyurethanes obtained by reacting a polyester obtained from adipic acid and/or terephthalic acid and/or sulphosiophthalic acid and a diol, with a pre-polymer with terminal isocyanate groups obtained from a polyoxyethylene glycol and a diisocyanate (FR-A-2 334 698);

ethoxylated monoamines or polyamines, polymers of ethoxylated amines (U.S. Pat. No. 4,597,898, EP-A-0 011 984);

Preferably, the fixative resins are selected from polyvinylpyrrolidones (PVP), or copolymers of polyvinylpyrrolidone and methyl methacrylate, polyvinylpyrrolidone and vinyl acetate (VA) copolymers, ethylene glycol polyterephthalate/polyethylene glycol copolymers, ethylene glycol polyterephthalate/polyethylene glycol/sodium polyisophthalate sulphonate copolymers, and mixtures thereof.

These fixative resins are preferably dispersed or dissolved in the selected vehicle.

The cosmetic compositions of the invention can also contain polymeric derivatives exerting a protective function.

Such polymeric derivatives can be present in said compositions in quantities of the order of 0.01%-10%, preferably about 0.1-5%, more particularly of the order of 0.2-3% by weight.

Such agents can be selected from:

non-ionic cellulose derivatives such as cellulose, methyl cellulose, ethyl cellulose, hydroxypropyl methyl cellulose or hydroxybutyl methyl cellulose hydroxyethers;

polyvinylesters grafted onto polyalkylene backbones, such as polyvinylacetates grafted onto polyoxyethylene backbones (EP-A-0 219 048);

polyvinyl alcohols.

The cosmetic compositions of the invention can also comprise plasticizers.

Said plasticizers, if present, can represent 0.1% to 20% of the formulation, preferably 1% to 15%.

Examples of plasticizers that can be cited are adipates, phthalates, isophthalates, azelates, stearates, copolyol silicones, glycols, castor oil or mixtures thereof.

It is also advantageous to add to these compositions metal sequestrating agents, more particularly calcium sequestrating agents such as citrate ions.

It is also possible to incorporate moisturising agents into the cosmetic compositions of the invention, examples being glycerol, sorbitol, urea, collagen, gelatine, aloe vera, hyaluronic acid or hydrosoluble volatile solvents such as ehtanol or propylene glycol, in amounts of up to 60% by weight of the composition.

To further reduce the irritation or aggravation of the scalp, it is also possible to add hydrosoluble or hydrodispersible polymers such as collagen or certain non allergising derivatives of animal or vegetable proteins (for example wheat germ protein hydrolysates), natural hydrocolloids (guar gum, carouba gum, tara gum, . . . ) or from fermentation methods and derivatives of these polycarbohydrates such as modified non-ionic celluloses, for example hydroxyethylcellulose, or anionic celluloses such as carboxymethylcellulose; guar derivatives or carouba derivatives such as their non ionic derivatives (for example hydroxypropylguar), or their anionic derivatives (carboxymethylguar and carboxymethyl hydroxypropyl guar).

Powders or mineral particles can be added to said compounds, for example calcium carbonate, sodium bicarbonate, calcium dihydrogen phosphate, mineral oxides in powder form or in colloidal form (particles with a size of less than or of the order of one micrometre, sometimes several tens of nanometres) such as titanium dioxide, silica, aluminium salts generally used as antiperspirants, kaolin, talc, clays and clay derivatives, etc . . .

Preservatives such as methyl, ethyl, propyl and butyl esters of p-hydroxybenzoic acid, sodium benzoate, GERMABEN® or any chemical agent preventing the proliferation of bacteria or moulds and traditionally used in cosmetic compositions, can also be introduced into the aqueous cosmetic compositions of the invention, generally in an amount of 0.01% to 3% by weight.

The quantity of these products is normally adjusted to prevent any proliferation of bacteria, moulds or yeasts in the cosmetic compositions.

As an alternative to the above chemical agents, agents can sometimes be used that modify the activity of water and greatly increase the osmotic pressure, such as carbohydrates or salts.

To protect the skin and/or hair against the sun and UV radiation, mineral particles can be added to the formulations such as zinc oxide, titanium dioxide or cerium oxides in the powder form or as colloidal particles, used alone or as a mixture. Those powders can optionally be surface treated to enhance the effectiveness of their anti-UV action or to facilitate their incorporation into the cosmetic formulations, or to inhibit surface photoreactivity.

If necessary, to increase comfort during use of the composition by the user, these ingredients can be supplemented with one or more fragrances, colouring agents including those in annex IV (“List of colouring agents allowed for use in cosmetic products”) in European directive n° 76/768/CEE dated Jul. 17, 1076, the cosmetics directive, and/or opacifying agents as pigments.

Although not obligatory, the composition can also contain viscosifying or gelling agents to adjust the texture of the composition, such as cross-linked polyacrylates (Carbopol sold by Goodrich), non-cationic derivatives of cellulose such as hydroxypropyl cellulose, carboxymethyl cellulose, guars and their non-ionic derivatives, xanthan gum and its derivatives, used alone or in association, or the same compounds, generally in the form of hydrosoluble polymers modified by hydrophobic groups covalently bonded to the polymer backbone, as described in International patent WO-A-92/16187 and/or water, to bring the total amount of constituents of the formulation to 100%.

The cosmetic compositions of the invention can also contain polymeric dispersing agents in a quantity of the order of 0.1-7% by weight, to control the calcium and magnesium hardness, agents such as:

hydrosoluble salts of polycarboxylic acids with a mass average molecular mass of the order of 2000 to 100000 g/mol, obtained by polymerisation or copolymerisation of ethylenically unsaturated carboxylic acids such as acrylic acid, maleic acid or anhydride, fumaric acid, itaconic acid, aconitic acid, mesaconic acid, citraconic acid, methytlenemalonic acid, and in particular polyacrylates with a mass average molecular weight of the order of 2000 to 10000 g/mol (U.S. Pat. No. 3,308,067), copolymers of acrylic acid and maleic anhydride with a mass average molecular weight of the order of 5000 to 75000 g/mol (EP-A-0 066 915);

polyethylene glycols with a mass average molecular weight of the order of 1000 to 50000 g/mol.

The following examples are given by way of illustration and in no way limit the scope of the invention.

### EXAMPLE 1

A 1% solution of the cationic polymers shown in the table below was prepared in distilled water using conventional methods.

The pH was adjusted to 6.5.

| | | | | Commercial | |
|---|---|---|---|---|---|
| | INCI name | | Origin | name | Supplier |
| Product A | Hydroxypropyl | guar | Guar | Jaguar C162 | Rhodia |
| | hydroxypropyl | trimonium | | | |
| | chloride | | | | |
| Product B | Hydroxypropyl | guar | Guar | Jaguar C135 | Rhodia |
| | hydroxypropyl | trimonium | | | |
| | chloride | | | | |
| Product C | Polyquaternium-10 | | Cellulose | Polymer JR400 | Union Carbide |
| Product D | Hydroxypropyl | guar | Guar | Jaguar Excel | Rhodia |
| | hydroxypropyl | trimonium | | | |
| | chloride | | | | |

Increasing concentrations of sodium laureth-2 sulphate (Empicol ESB3M, 28% activity, used as is) were added to these solutions.

After leaving for one hour at ambient temperature, the viscosity was measured (Brookfield, screw 4, 1 rpm).

The results are shown in the graph of FIG. 1.

It can be seen that the viscosity ratio Vs, defined as the ratio between the maximum viscosity in the presence of surfactant and the viscosity in the absence of surfactant, is between 2.6 and 57 depending on the nature of the cationic polymer.

### EXAMPLE 2

The properties of cationic polymer D were compared with those of a conventional associative thickening agent, tetradecyl hydroxypropyl guar, prepared by condensation of C14 chains with hydroxypropyl guar (see EP-A-0 281 360).

A solution of the polymers described in the table below was prepared in a concentration of 1% by weight in distilled water using conventional methods.

The pH was adjusted to 6.5.

| | INCI name | | Origin | Commercial name | Supplier |
|---|---|---|---|---|---|
| Product E | Tetradecyl hydroxypropyl guar | | Guar | — | Rhodia |
| Product D | Hydroxypropyl | guar | Guar | Jaguar Excel | Rhodia |
| | hydroxypropyl | trimonium | | | |
| chloride | | | | | |

Increasing concentrations of sodium laureth-2 sulphate (Empicol ESB3M, 28% activity, used as is) were added to these solutions.

After leaving for one hour at ambient temperature, the viscosity was measured (Brookfield, screw 4, 1 rpm).

The results are shown in the graph of FIG. 2.

The viscosity ratio Vs, defined as the ratio between the maximum viscosity in the presence of surfactant and the viscosity in the absence of surfactant, was 1.45 for the traditional substance and 33.3 for the cationic polymer.

### EXAMPLE 3

The compatibility of the cationic polymers was tested in the presence of alcohol.

A solution of cationic polymers (1% by weight) described in the table below was prepared in distilled water containing variable propotions of ethanol (20%, 40%, 60% for product A; 20% and 60% for product C), using conventional methods.

The pH was adjusted to 6.5.

| | INCI name | | Origin | Commercial name | Supplier |
|---|---|---|---|---|---|
| Product A | Hydroxypropyl | guar | Guar | Jaguar C162 | Rhodia |
| | hydroxypropyl | trimonium | | | |
| | chloride | | | | |
| Product C | Polyquaternium-10 | | Cellulose | Polymer JR400 | Union Carbide |

Increasing concentrations of sodium laureth-2 sulphate (Empicol ESB3M, 28% activity, used as is) were added to these solutions.

After leaving for one hour at ambient temperature, the viscosity was measured (Brookfield, screw 4, 1 rpm).

The results are shown in the graph of FIG. 3.

The two cationic polymers have good compatibilities in a hydroalcoholic medium with viscosity ratios of more than 2 for alcohol contents of less than 40%. The position of the maximum viscosity peak depends on the nature of the cationic polymer.

### EXAMPLE 4

A hair gel was prepared with the following composition:

| | | | Concentration |
|---|---|---|---|
| | INCI name | Commerical name | (%) |
| 1 | Polyquaternium-10 | Polymer JR400 (Union | 1 |
| | | Carbide) | |
| 2 | Sodium Laureth-2- | (Empicol ESB3M, 28% | 0.4 |
| | sulphate | activity, used as is) | |
| 3 | Dimethicone copolyol | Mirasil DMCO | 1.5 |
| 4 | Ethanol | — | 15 |
| 5 | Parfum | — | Qs 100% |
| 6 | Citric acid | — | Qs (pH 6.5) |

A transparent gel was obtained with a rheofluidifying character endowing it with good distribution properties. It had good fixing power, was not tacky, and left no residue in the hair.

1. Aqueous cosmetic compositions comprising a mixture:
of at least one anionic surfactant, in an amount of the order of 0.001% to 1.5% by weight;
of at least one cationic polymer, in an amount of the order of 0.01% to 2% by weight, said cationic polymer being selected so that the viscosity ratio Vs, defined as the ratio between the maximum viscosity in the presence of surfactant and the viscosity in the absence of surfactant, is a minimum of 2.

2. A composition according to the preceding claim, characterized in that it comprises of the order of 0.1% to 1% by weight of anionic surfactant.

3. A composition according to any one of the preceding claims, characterized in that it comprises of the order of 0.01% to 1% by weight of cationic polymer, preferably of the order of 0.01% to 0.5% by weight of cationic polymer.

4. A composition according to any one of the preceding claims, characterized in that the anionic surfactant is selected from:
alkylester sulphonates with formula R—CH(SO₃M)—COOR′, where R represents a C₈-C₂₀ alkyl radical, R′ represents a C₁-C₆ alkyl radical, and M represents an alkali cation or substituted or non substituted or alkanolamine-derived ammonium;
alkylsulphates with formula ROSO₃M, where R represents a C₁₀-C₂₄ alkyl or hydroxyalkyl radical, M represents a hydrogen atom or an alkali cation or substituted or non substituted or alkanolamine-derived ammonium, and their oxyalkylenated derivatives with an average of 0.5 to 6 oxyalkylenated motifs;
alkylamide sulphates with formula RCONHR′OSO₃M where R represents a C₂-C₂₂ alkyl radical, R′ represents a C₂-C₃ alkyl radical, M represents a hydrogen atom or an alkali cation, or a substituted or non substituted or alkanolamine-derived ammonium, and their oxyalkylenated derivatives with an average of 0.5 to 60 motifs oxyalkylenated motifs;
salts of saturated or unsaturated C₈-C₂₄ fatty acids;
C₉-C₂₀ alkylbenzenesulphonates, primary or secondary C₈-C₂₂ alkylsulphonates, alkylglycerolsulphonates, sulphonated polycarboxylic acids, paraffin sulphonates, N-acyl-N-alkyltaurates, alkylphosphates, alkylisethionates, alkylsuccinamates, alkylsulphosuccinates, sulphosuccinate monoesters or diesters, N-acylsarcosinates, alkylglycoside sulphates or polyethoxycarboxylates.

5. A composition according to any one of the preceding claims, characterized in that it comprises at least one co-surfactant.

6. A composition according to the preceding claim, characterized in that the co-surfactant is selected from non-ionic, amphoteric and zwitterionic surfactants.

7. A composition according to any one of the preceding claims, characterized in that the cationic polymer is selected from cationic polsaccharide derivatives or synthetic polymers.

8. Use of a mixture comprising:
of the order of 0.001% to 1.5% by weight of at least one anionic surfactant;
of the order of 0.01% to 2% by weight of at least one cationic polymer, the cationic polymer being selected so that the viscosity ratio Vs, defined as the ratio between the maximum viscosity in the presence of surfactant and the viscosity in the absence of surfactant, is a minimum of 2;
as a structuring agent for aqueous cosmetic compositions.
